(19) United States
(12) Patent Application Publication
(10) Pub. No.: US 2023/0252115 A1
(43) Pub. Date: Aug. 10, 2023

(54) ARTIFICIALLY-INTELLIGENT, DYNAMIC, RULES-BASED SYSTEM FOR AUTHENTICATING, VERIFYING, AND DIGITALLY ONBOARDING PROSPECTIVE ACCOUNT HOLDERS

(71) Applicant: Bank of America Corporation, Charlotte, NC (US)

(72) Inventors: Preston Wesley Ports, III, Charlotte, NC (US); Ryan J. Moore, Bangor, ME (US); Sangeeta Varma Martinez, Aliso Viejo, CA (US); Robert Marshall Voyles, III, Tustin, CA (US); Ryan M. Furey, Charlotte, NC (US); Erin Marie McCullen, Charlotte, NC (US); Ankana Datta, Philadelphia, PA (US); Kyle Corkery, Charlotte, NC (US)

(21) Appl. No.: 17/668,507

(22) Filed: Feb. 10, 2022

(51) Int. Cl. G06F 21/31

(52) U.S. Cl. CPC G06F 21/31; G06F 2221/2115; G06F 2221/2117

(57) ABSTRACT

Methods for authenticating, verifying and digitally onboarding prospective account holders using an artificially-intelligent, dynamic, rules-based system are provided. Methods may include receiving digital requests for digital account onboarding. Methods include processing the digital requests at a rules engine. Methods may include generating an authentication and verification score for each digital request. Methods may include initiating one or more authentication and verification systems to authenticate and/or verify a prospective account holder associated with each digital request. Methods may include identifying an authentication and verification score for each digital request based the results of the authentication and verification systems. Methods may include creating accounts for account holders that are authenticatable and verifiable by the authentication and verification systems. Methods may include denying digital account onboarding for account holders that are not authenticatable and verifiable by the authentication and verification systems.

### FIELD OF TECHNOLOGY

Aspects of the disclosure relate to account holder authentication and verification.

### BACKGROUND OF THE DISCLOSURE

Conventionally, digital onboarding of accounts was limited to populations that were authenticatable and verifiable through a specific, pre-approved channel. However, limiting digital onboarding of accounts to a pre-approved channel may preclude opening of accounts that are authenticatable through other valid channels. Therefore, it would be desirable to create a system that increases the throughput of digital account creation by enabling the authentication and verification process to access multiple channels.

### SUMMARY OF THE DISCLOSURE

Apparatus and methods for an artificially-intelligent, dynamic, rules-based system for authenticating and verifying prospective account holders are provided. The system may authenticate and verify the account holders with respect to decisioning which prospective account holders qualify for digital account onboarding.

It should be appreciated that prospective accounts holders may be categorized in one or more populations, or groupings of people. Each population may have its own set of characteristics. Each population may therefore be authenticatable and/or verifiable using a different system, tool or organization. For the purposes of this application, authentication may be understood to mean one or more systems or processes that ensure that a person exists, while verification may be understood to mean one or more systems or processes that ensure that the person who was authenticated is the person submitting the application.

Authentication and verification of prospective account holders in all populations may initially be processed by a rules engine. The rules engine may receive digital account applications. The digital applications may be received on a webpage or application. The webpage or application may be executing on a personal computer (“PC”), mobile device or any other suitable computing device. The digital applications may request data from the prospective account holder. Such data may include name, address, phone number, social security number, date of birth and any other suitable data.

The rules engine may approve the applications, reject the applications, or hold the applications for further consideration and review. The applications may be approved, rejected or held based on the classification of one or more rules included in the rules engine. Examples of the one or more rules may include classifying applications that arrive from certain geographical parameters, classifying applications for certain age groups, classifying applications from certain internet protocol (“IP”) address ranges, classifying multiple applications received from identical or similar locations, classifying applications associated with an account holder that has been previously associated with certain keywords and classifying applications that include certain anomalies, such as relatively rapid address changes.

At times, based on the classification of the application by the rules engine, applications may be immediately rejected. Such immediately rejected applications may be presented to a prospective account holder as rejected. The rejection may be displayed on a display of the PC or mobile device. While the applications may be rejected by the rules engine, the prospective account holder may be able to complete the account registration and completion process at a financial center. Therefore, the system may provide a rejected applicant the capability to store the partially completed application so that the applicant may complete the application at a financial center in a relatively short time period.

At times, based on the classification of the application by the rules engine, applications may be placed on hold. Such on-hold applications may be displayed to a prospective account holder as under review. The on-hold applications may be processed by an electronic review engine or a review team. Upon confirmation from the electronic review engine or review team, the on-hold applications may be approved or rejected. Once the application is approved or rejected, the decision may be displayed or transmitted to the prospective account holder. However, the system may provide the rejected applicant the capability to store the partially completed application so that the application may be completed in a relatively short time period at a financial center.

Additionally, the rules engine may operate in a dynamic matter. As such, rules may be weighted based on a machine-learning based feedback loop. Therefore, rules that have caused worthwhile applications to be rejected may be assigned less weight in future applications. Additionally, if a specific rule has caused the cancellation of more than a predetermined number of worthwhile applications, the specific rule may be cancelled, deleted or archived within the rules engine.

At times, the prospective account holder and associated application may be approved by the rules engine. As such, the prospective account holder may be authenticated and verified by one or more authentication and verification components.

It should be noted that the rules engine may operate in tandem with the authentication and verification components. The operation of the authentication and verification components may be enmeshed with the operation of the rules engine. As such, certain rules may be applicable and executable prior to the authentication and/or verification, certain rules and executable may be applicable after authentication and prior to verification and certain rules may be applicable and executable post-authentication and verification.

The selection of which authentication and verification components to be used may be based, in part or in whole, on the population in which the prospective account holder is classified. Also, more than one authentication and verification component may be used for a prospective account holder.

The authentication and verification components may involve communication with a national credit bureau. When a prospective account holder is authenticatable and verifiable using a social security number input into a national credit bureau, the account holder may be able to be onboarded digitally. Specifically, the national credit bureau may authenticate and verify the prospective account holder.

However, there are populations that are not authenticatable and verifiable via the national credit bureau. Such populations may involve potential account holders that do not have adequate national credit scores and national credit details available within the national credit bureau. Such populations, that include account holders that do not have adequate national credit scores and national credit details, may include account holders that are under a predetermined age, such as age eighteen. These account holders may be authenticatable and verifiable via a third-party vendor for authenticating and verifying account holders. The third-party vendor for authenticating and verifying account holders may also be referred to as a third-party person recognition system.

A third-party vendor for authenticating and verifying account holders may have access to a plurality of databases. Such databases may be able to authenticate and/or verify a prospective account holder by retrieving data from the prospective account holder and verifying the data with one or more of the plurality of databases. The retrieved data may include, for example, a name, a social security number, a driver’s license number, a driver’s license expiration date, an address, a mobile device number, a date of birth, a proof of residency and any other suitable information. In order to verify a prospective account holder under age eighteen, the third-party vendor may access, for example, a state database that issued the prospective account holder’s driver’s license. The third-party may enter the prospective account holder’s driver’s license data, such a driver’s license number, a driver’s license expiration date, a date of birth, a name, an address and/or any other suitable data. In the event that the data matches data that has been stored at the state database, the third-party vendor may authenticate and verify the application.

Certain populations may be authenticated via a Social Security Administration Access system. The Social Security Administration access system may receive data relating to a prospective account holder. Such data may include, for example, a social security number, name, date of birth and any other suitable data. The data may be used to verify that this social security number associated with the prospective account holder is indeed valid for this specific name and date of birth.

Certain populations may be authenticated via an international credit bureau. The international credit bureau may verify and authenticate prospective account holders using a name, address, phone number, passport number or any other suitable personal data.

It should be noted that multiple authentication and verification components may be used in tandem in order to authenticate and verify a prospective account holder. As such, a national credit bureau, the Social Security Administration Access system, the third-party vendor for authenticating and verifying account holders and/or the international credit bureau may be used to verify and authenticate a prospective account holder.

It should be noted that national citizens may be able to be digitally onboarded at any location in the world. However, non-resident foreign nationals may only be able to be digitally onboarded if they are currently residing in a specific country. Therefore, a proof of residency, such a W-9 form, utility bill or lease document may be uploaded in order to complete a digital account application.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows an illustrative flow chart in accordance with principles of the disclosure;

FIG. 4 shows an illustrative diagram in accordance with principles of the disclosure;

FIGS. 5A and 5B show illustrative diagrams in accordance with principles of the disclosure.

### DETAILED DESCRIPTION OF THE DISCLOSURE

Apparatus and methods for an artificially-intelligent, dynamic, rules-based system for authenticating and verifying prospective account holders with respect to decisioning which prospective account holders qualify for digital account onboarding are provided.

The system may include an initial digital application intake module. The intake module may reside on a server. The server may be executing at an institution. The server may operate in a client-server mode with a client device. The client device may be a mobile device, PC or any other suitable device.

The client device may execute a user interface (“UI”). The user interface may be web-based. The web-based user interface may communicate with the initial digital application intake module. The user interface in communication with the digital application intake module may be referred to collectively as the digital application intake module.

The digital application intake module may receive a plurality of digital account applications from a plurality of prospective account holders. The module may identify a first plurality of digital account applications. Each prospective account holder identified within the first plurality may be electronically authenticatable and verifiable via a national credit bureau.

The module may forward the first plurality of applications for authentication and verification by the national credit bureau. The module may determine, by a processor interfacing with a rules engine and the national credit bureau, an authentication and verification score for each application included in the first plurality of digital account applications.

The module may identify a second plurality of digital account applications. Each prospective account holder included in the second plurality of digital account applications may be electronically authenticatable and verifiable via a third-party person authentication and verification system. The module may forward the second plurality of digital account applications for authentication and verification to the third-party person authentication and verification system.

The third-party person authentication and verification system may verify each prospective account holder based on records relating to when each prospective account holder registered for a mobile device. The third-party person authentication and verification system may also verify each prospective account holder based on records relating to a driver’s license of each prospective account holder. The third-party person authentication and verification system may also verify each prospective account holder based on records relating to one or more social media accounts of each prospective account holder.

The module may determine, by a processor interfacing with the rules engine and the third-party person authentication and verification system, an authentication and verification score for each digital account application included in the second plurality of digital account applications.

The module may identify a third plurality of digital account applications. Each prospective account holder may electronically authenticatable and verifiable via a third-party access system to a Social Security Administration. The module may forward the third plurality of digital account applications to the third-party access system to the Social Security Administration. The third-party access system to the Social Security Administration may authenticate and verify each prospective account holder based on a comparison between a plurality of data elements associated with each prospective account holder and a plurality of data elements associated with an assigned and recorded social security number. The plurality of data elements may include a name, address, date of birth and/or social security number.

The module may determine, by a processor interfacing with the rules engine and the third-party access system to the Social Security Administration, the authentication and verification score for each application included in the third plurality of digital account applications.

At times, the module may identify a fourth plurality of digital account applications from the plurality of digital account applications. Each prospective account holder, identified within the fourth plurality of digital account applications, may be electronically authenticatable and verifiable via an international credit bureau.

The module may forward the fourth plurality of digital account applications to the international credit bureau for authentication and verification. The module may determine, by a processor, interfacing with a rules engine and the international credit bureau, an authentication and verification score for each application included in the fourth plurality of digital account applications.

It should be appreciated that a digital account application may be included in more than one plurality of digital account applications. As such, a digital account application may be included in the first plurality of digital account applications, the second plurality of digital account applications, the third plurality of digital account applications and/or the fourth plurality of digital account applications.

The module may receive the authentication and verification score for each digital account application. The score may be received from the national credit bureau, the third-party person authentication and verification system, the third-party access system to the Social Security Administration and/or the international credit bureau.

The module may create digitally on-boardable accounts for prospective account holders whose authentication and verification score are above a first predetermined threshold. The module may deny digitally on-boardable accounts for prospective account holders whose authentication and verification score are below a second predetermined threshold.

The module may review, at a rules engine, account for prospective account holders whose authentication and verification score is lower than the first predetermined threshold and higher than the second predetermined threshold. Based on the review, the module may create or deny digitally on-boardable accounts for prospective account holders. For each account under review, the rules engine may identify whether the prospective account holder is an authenticable and verifiable account holder.

At times, when a digital application, associated with a prospective account holder, was reviewed and then determined to be authenticatable and verifiable, the module may perform a dynamic rule calibration process. Such a rule calibration process identify one or more rules, included in the rules engine that caused the authentication and verification score to be below the first predetermined threshold. The module may then lower the weighting of the one or more rules at the rules engine.

Also, the rules engine may identify that greater than a predetermined threshold number of prospective account holders have been denied valid digital on-boardable accounts because of a first rule included in the rules engine. Upon such identification, the rules engine may delete, or archive, the first rule from the rules engine.

At times, a digital account application may be denied digital on-boarding. However, in order to preserve the time and effort that it took the applicant to enter the data into the digital application, a storage module may be made available. The storage module may store the digital account applications associated with denied digitally on-boardable accounts. The storage module may also instruct the prospective account holders regarding one or more physical documents required to complete the digital account applications.

The storage module may instruct the prospective account holders associated with the stored digital account applications to complete the application at one of a plurality of geographical locations. The geographical locations may include physical financial centers and/or a plurality of kiosks.

The system may also include a remote account completion module. The remote account completion module may operate at the financial centers and/or at the plurality of kiosks. The remote account completion module may receive a request to complete the digital account application. The remote account completion module may remotely access the stored digital account application within the storage module. The remote account completion module may receive and scan the one or more physical documents required to complete the digital account application. The remote account completion module may create an account for the digital account application.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

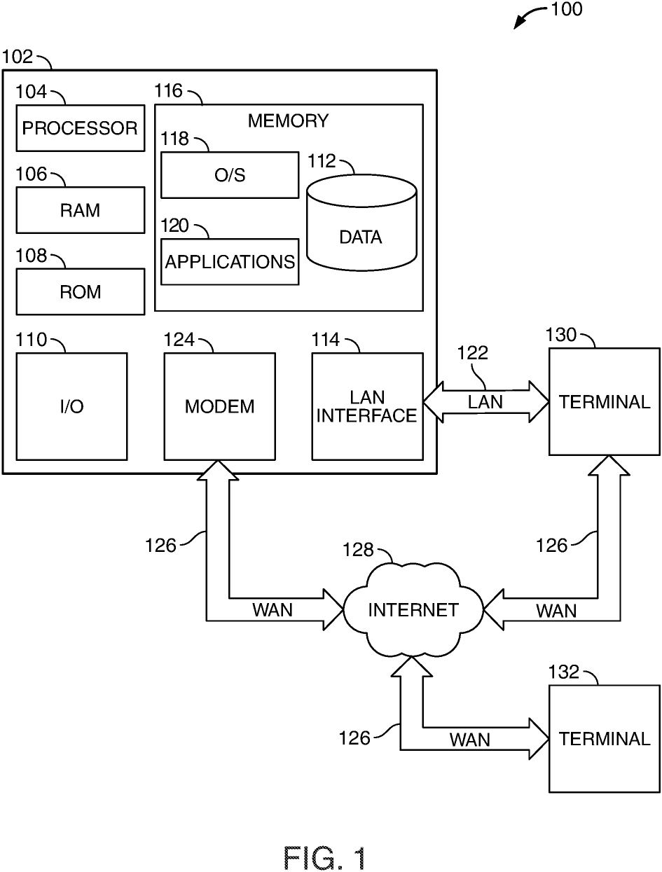

FIG. 1 shows an illustrative block diagram of system 100 that includes computer 102. Computer 102 may alternatively be referred to herein as an “engine,” “server” or a “computing device.” Computer 102 may be a workstation, desktop, laptop, tablet, smartphone, or any other suitable computing device. Elements of system 100, including computer 102, may be used to implement various aspects of the systems and methods disclosed herein.

Computer 102 may have a processor 104 for controlling the operation of the device and its associated components, and may include RAM 106, ROM 108, input/output circuit 110, and a non-transitory or non-volatile memory 116. Machine-readable memory may be configured to store information in machine-readable data structures. The processor 104 may also execute all software running on the computer. Other components commonly used for computers, such as EEPROM or Flash memory or any other suitable components, may also be part of the computer 102.

The memory 116 may be comprised of any suitable permanent storage technology-e.g., a hard drive. The memory 116 may store software including the operating system 118 and application(s) 120 along with any data 112 needed for the operation of the system 100. Memory 116 may also store videos, text, and/or audio assistance files. The data stored in Memory 116 may also be stored in cache memory, or any other suitable memory.

Input/output (“I/O”) module 110 may include connectivity to a microphone, keyboard, touch screen, mouse, and/or stylus through which input may be provided into computer 102. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (“LAN”) interface 114. System 100 may operate in a networked environment supporting connections to one or more remote computers, such as terminals 130 and 132. Terminals 130 and 132 may be personal computers or servers that include many or all of the elements described above relative to system 100. The network connections depicted in FIG. 1 include a local area network (“LAN”) 122 and a wide area network (“WAN”) 126 but may also include other networks. When used in a LAN networking environment, computer 102 is connected to LAN 122 through a LAN interface 114 or an adapter. When used in a WAN networking environment, computer 102 may include a modem 124 or other means for establishing communications over WAN 126, such as Internet 128.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 120, which may be used by computer 102, may include computer executable instructions for invoking functionality related to communication, such as e-mail, Short Message Service (SMS), and voice input and speech recognition applications. Application program(s) 120 (which may be alternatively referred to herein as “plugins,” “applications,” or “apps”) may include computer executable instructions for invoking functionality related to performing various tasks. Application program(s) 120 may utilize one or more algorithms that process received executable instructions, perform power management routines or other suitable tasks. Application program(s) 120 may utilize one or more decisioning processes for the processing of calls received from calling sources as detailed herein.

Application program(s) 120 may include computer executable instructions (alternatively referred to as “programs”). The computer executable instructions may be embodied in hardware or firmware (not shown). The computer 102 may execute the instructions embodied by the application program(s) 120 to perform various functions.

Application program(s) 120 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 112, and any other suitable information, may be stored in memory 116.

The invention may be described in the context of computer-executable instructions, such as applications 120, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 102 and/or terminals 130 and 132 may also include various other components, such as a battery, speaker, and/or antennas (not shown). Components of computer system 102 may be linked by a system bus, wirelessly or by other suitable interconnections. Components of computer system 102 may be present on one or more circuit boards. In some embodiments, the components may be integrated into a single chip. The chip may be silicon-based.

Terminal 130 and/or terminal 132 may be portable devices such as a laptop, cell phone, tablet, smartphone, or any other computing system for receiving, storing, transmitting and/or displaying relevant information. Terminal 130 and/or terminal 132 may be one or more user devices. Terminals 130 and 132 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

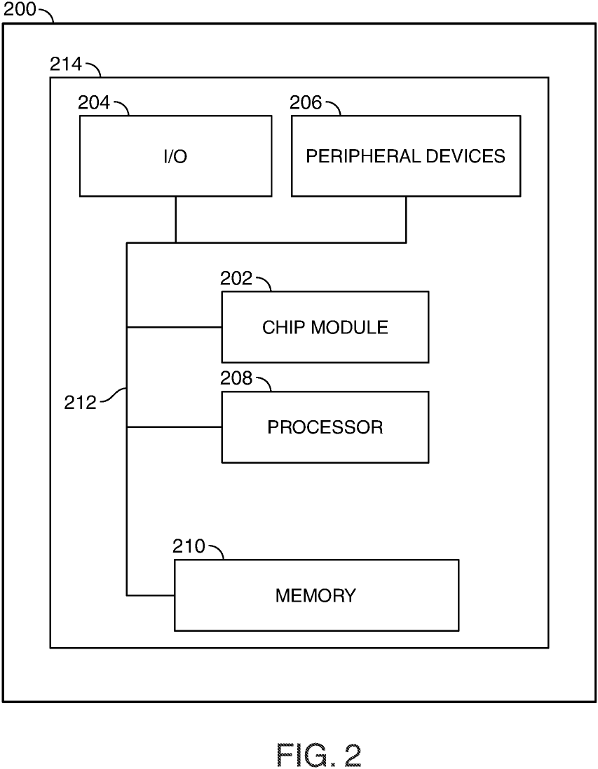

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 120, signals, and/or any other suitable information or data structures.

Components 202, 204, 206, 208 and 210 may be coupled together by a system bus or other interconnections 212 and may be present on one or more circuit boards such as circuit board 214. In some embodiments, the components may be integrated into a single chip. The chip may be silicon-based.

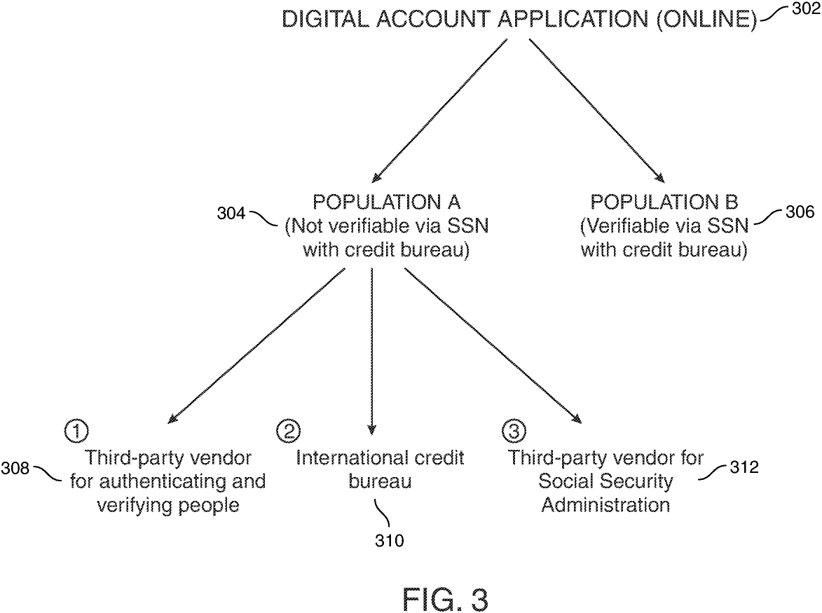

FIG. 3 shows an illustrative flow chart. Flow chart 300 shows various populations and methods for authenticating and verifying each of the populations. A customer may apply for an account using a digital process. A digital process may include submitting an account application using an online forum, such as a mobile device or PC. A digital process may preferably not involve an a physical in-person visit to a financial center.

A backend system to the digital account platform may identify whether a customer falls into population A and/or population B. Customers that fall into population B may be electronically authenticatable and verifiable via checking a social security number with a national credit bureau. It should be noted that an authentication process may ensure that this person exists, while the verification process ensures that this person who was authenticated is the person submitting the application.

Customers that fall into population A may be unable to be verified via a national credit bureau. This may be because those in population A may not have national credit, such as those who are under a predetermined age or foreign nationals who arrived in another country.

Customers in population A may be authenticated and verified in one or more of three ways. A first way to authenticate and/or verify customers in population A may be a third-party vendor for authenticating and verifying account holders. The third-party vendor may request the name, license number and expiration date of the prospective account holder’s driver’s license. The third-party vendor may authenticate the license with the state that issued the license. The third-party vendor may also authenticate the prospective account holder with mobile device registration records. Accordingly, the third-party vendor may compare the current name, address and/or mobile device number of the prospective account holder with a list of mobile device registrations and purchases. The list of mobile device registrations and purchases may include mobile device numbers, names and addresses associated with each of the mobile device registrations and purchases. The third-party vendor may also authenticate the prospective account holder with records relating to when the account holder was registered in either elementary school or high school.

A second way to authenticate and verify customers in population A may be an international credit bureau. An international credit bureau may be a credit bureau that is recognized and accessible worldwide. Such an international credit bureau may be specifically useful for a population that includes foreign nationals.

A third way to authenticate and verify customers in population A may be a third-party vendor for a Social Security Administration. Such a third-party vendor may transmit a social security number, name and date of birth to the Social Security Administration. The Social Security Administration may indicate whether or not such a person exists within the Social Security Administration records.

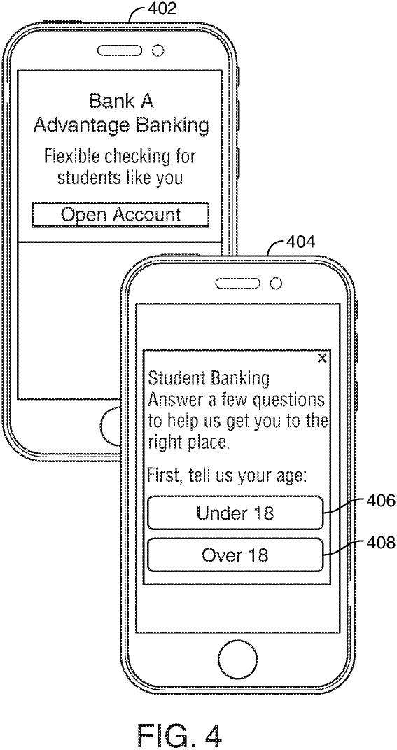

FIG. 4 shows an illustrative diagram. Mobile device screenshot 402 shows a user attempting to open a digital account. Mobile device screenshot 404 shows enabling a user to select their age in order to establish an account. Based on the selected age, the user may be included a different population. The selected age may be one of the factors in determining an authentication and verification process.

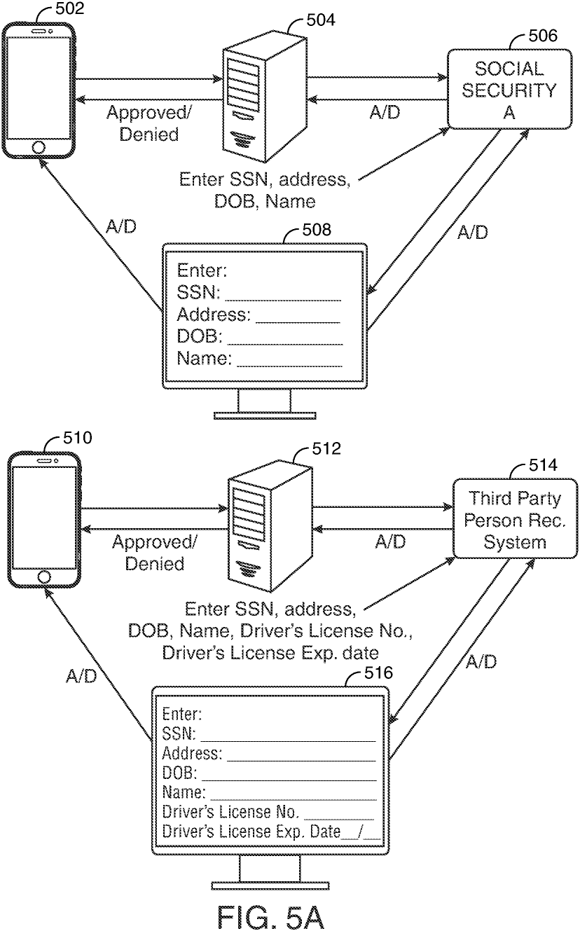

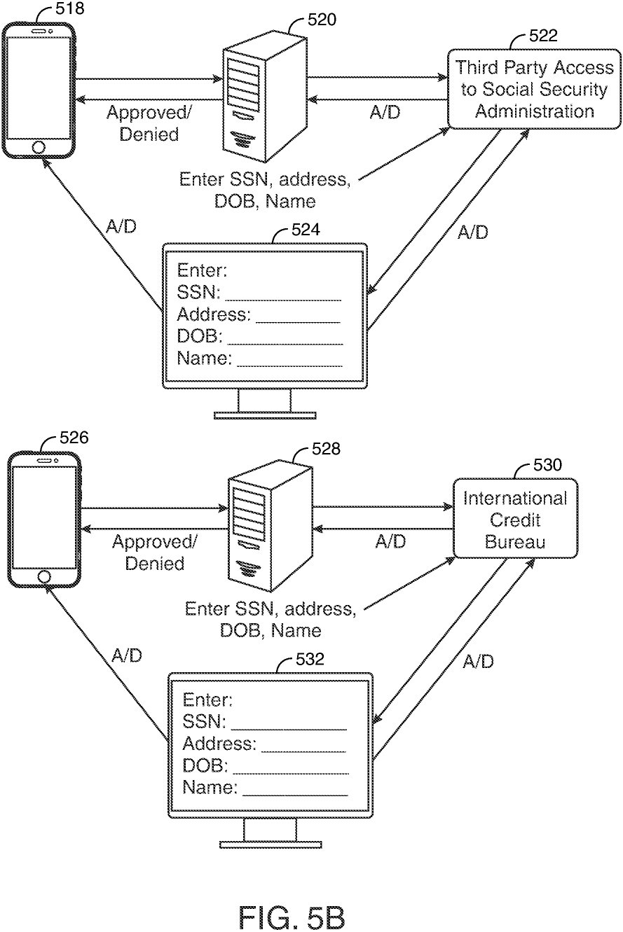

FIG. 5A shows two illustrative diagrams. The first illustrative diagram shows mobile device 502, server 504, credit bureau 506 and UI 508. Mobile device 502 may communicate with server 504 to approve a digital application. The digital application may instantiate an application programing interface (“API”) at server 504. The digital application may also instantiate a UI 508. Either the API or UI 508 may access credit bureau 506 for an approval, denial and/or an authentication and verification score. The approval, denial and/or an authentication and verification score may be forwarded to the mobile device either via the API and/or via the user interface. The approval, denial and/or the authentication and verification score may also be transmitted directly from server 504 to mobile device 502.

The second illustrative diagram shows mobile device 510, server 512, third-party person recognition system 514 and user interface 516. Mobile device 502 may communicate with server 504 to approve a digital application. The digital application may instantiate an API at server 512. The digital application may also instantiate a user interface 516. Either the API or the UI 516 may access third-party person recognition system 514 for an approval, denial and/or an authentication and verification score. The approval, denial and/or an authentication and verification score may be forwarded to the mobile device either via the API and/or via the user interface. The approval, denial and/or the authentication and verification score may also be transmitted directly from server 512 to mobile device 510.

FIG. 5B shows two illustrative diagrams. The first illustrative diagram shows mobile device 518, server 520, third-party access to Social Security Administration 522 and user interface 524. Mobile device 518 may communicate with server 520 to approve a digital application. The digital application may instantiate an API at server 520. The digital application may also instantiate a user interface 524. Either the API or the UI 524 may access third-party access to Social Security Administration 522 for an approval, denial and/or an authentication and verification score. The approval, denial and/or an authentication and verification score may be forwarded to the mobile device either via the API and/or via the user interface. The approval, denial and/or the authentication and verification score may also be transmitted directly from server 520 to mobile device 518.

The second illustrative diagram shows mobile device 526, server 528, international credit bureau 530 and user interface 532. Mobile device 526 may communicate with server 528 to approve a digital application. The digital application may instantiate an API at server 528. The digital application may also instantiate a user interface 532. Either the API or the UI 516 may access international credit bureau 530 for an approval, denial and/or an authentication and verification score. The approval, denial and/or an authentication and verification score may be forwarded to the mobile device either via the API and/or via the user interface. The approval, denial and/or the authentication and verification score may also be transmitted directly from server 528 to mobile device 526.

Thus, an artificially-intelligent, machine-learning, dynamic, rules-based system for authenticating, verifying and digitally onboarding prospective account holders is provided. Persons skilled in the art will appreciate that the present invention can be practiced by other than the described embodiments, which are presented for purposes of illustration rather than of limitation. The present invention is limited only by the claims that follow.

What is claimed is:

1. An artificially-intelligent, dynamic rules-based system for authenticating and verifying prospective account holders with respect to decisioning which prospective account holders qualify for digital account onboarding, the system comprising:
an initial digital application intake module, said initial digital application intake module operable to:
receive a plurality of digital account applications from a plurality of prospective account holders;
identify a first plurality of digital account applications from the plurality of digital account applications, each prospective account holder identified within the first plurality of digital account applications being electronically authenticatable and verifiable via a national credit bureau;
forward the first plurality of digital account applications to the national credit bureau for authentication and verification;
determine, by a processor interfacing with a rules engine and the national credit bureau, an authentication and verification score for each application included in the first plurality of digital account applications;
identify a second plurality of digital account applications from the plurality of digital account applications, each prospective account holder identified within the second plurality of digital account applications being electronically authenticatable and verifiable via a third-party person authentication and verification system;
forward the second plurality of digital account applications to the third-party person authentication and verification system for authentication and verification;
determine, by a processor interfacing with the rules engine and the third-party person authentication and verification system, an authentication and verification score for each digital account application included in the second plurality of digital account applications;
identify a third plurality of digital account applications from the plurality of digital account applications, each prospective account holder identified within the third plurality of digital account applications being electronically authenticatable and verifiable via a third-party access system to a Social Security Administration;
forward the third plurality of digital account applications to the third-party access system to the Social Security Administration for authentication and verification;
determine, by a processor interfacing with the rules engine and the third-party access system to the Social Security Administration, the authentication and verification score for each application included in the third plurality of digital account applications;
receive, from the national credit bureau, the third-party person authentication and verification system and the third-party access system to the Social Security Administration, for each application included in the first plurality of digital account applications, the second plurality of digital account applications and the third plurality of digital account applications, the authentication and verification score;
create digitally on-boardable accounts for prospective account holders whose authentication and verification score are above a first predetermined threshold;
deny digitally on-boardable accounts for prospective account holders whose authentication and verification score are below a second predetermined threshold;
review, at a rules engine, accounts for prospective account holders whose authentication and verification score is lower than the first predetermined threshold and higher than the second predetermined threshold; and
based on the review, creating or denying digitally on-boardable accounts for prospective account holders;
for each account under review, the rules engine operable to:
identify whether the prospective account holder is an authenticatable and verifiable account holder;
when the prospective account holder is authenticatable and verifiable, identifying one or more rules, included in the rules engine, that caused the authentication and verification score to be below the first predetermined threshold; and
lower a weighting of the one or more rules at the rules engine.

2. The system of claim 1, wherein the rules engine is further operable to:
identify that greater than a predetermined threshold number of the plurality of prospective account holders have been denied digital on-boardable accounts because of a first rule included in the rules engine; and
deleting the first rule from the rules engine.

3. The system of claim 1, wherein the initial digital application intake module is further operable to:
identify a fourth plurality of digital account applications from the plurality of digital account applications, each prospective account holder, identified within the fourth plurality of digital account applications, being electronically authenticatable and verifiable via an international credit bureau; and
forward the fourth plurality of digital account applications to the international credit bureau for authentication and verification.

4. The system of claim 1, further comprising a storage module initiated for denied digitally on-boardable accounts, said storage module operable to:
store the digital account applications associated with denied digitally on-boardable accounts; and
instruct the prospective account holders associated with the stored digital account applications to complete the application at one of a plurality of geographical locations.

5. The system of claim 1, further comprising a storage module initiated for denied digitally on-boardable accounts, said storage module operable to:
store the digital account applications associated with the denied digitally on-boardable accounts; and
instruct the prospective account holders regarding one or more physical documents required to complete the digital account applications; and
instruct the prospective account holders associated with the stored digital account applications to complete the application at one of a plurality of kiosks.

6. The system of claim 5, further comprising a remote account completion module operating on the plurality of kiosks, said remote account completion module operable to:
receive a request to complete a digital account application;
remotely access the stored digital account application within the storage module;
receive and scan the one or more physical documents required to complete the digital account application; and
create an account for the digital account application.

7. The system of claim 1, wherein the third-party access system to the Social Security Administration authenticates and verifies each prospective account holder based on a comparison between a name, address, date of birth and social security number associated with each prospective account holder and a name, address and date of birth associated with an assigned and recorded social security number.

8. The system of claim 1, wherein the third-party person authentication and verification system authenticates and verifies each prospective account holder based on at least one of:
records relating to when each prospective account holder registered for a mobile device;
records relating to a driver’s license of each prospective account holder; and
records relating to one or more social media accounts of each prospective account holder.

9. A method for authenticating, verifying and digitally onboarding prospective account holders using an artificially-intelligent, dynamic, rules-based system, the method comprising:
receiving a digital request, from a prospective account holder, to open an account;
processing the digital request at a rules engine, said rules engine comprising a plurality of rules, each of the plurality of rules being associated with a dynamic, weighted score;
generating, at the rules engine, an authentication and verification score for the digital request;
performing at least one of the following:
initiating a first authentication and verification of the account holder using a social security number inputted into a credit bureau;
initiating a second authentication and verification of the account holder via a third-party person recognition system; and
initiating a third authentication and verification of the account holder via a Social Security Administration access system;
updating the authentication and verification score based on the first authentication and verification, second authentication and verification and/or third authentication and verification;
when the updated authentication and verification score is above a first predetermined threshold, creating an account for the account holder;
when the updated authentication and verification score is below a second predetermined threshold, failing to create the account for the account holder;
when the updated authentication and verification score is between the second predetermined threshold and the first predetermined threshold, performing a detailed review of data relating to the account holder;
upon completion of the detailed review of data relating to the account holder, identify whether the account holder is an electronically authenticatable and verifiable account holder;
when the account holder is an electronically authenticatable and verifiable, identifying one or more rules, included in the rules engine, that caused the authentication and verification score to be below the first predetermined threshold; and
lower a weighting of the one or more rules at the rules engine.

10. The method of claim 9, wherein the third-party person recognition system authenticates and verifies the account holder based on at least one of:
records relating to when the prospective account holder registered for a mobile device;
records relating to a driver’s license of the prospective account holder; and
records relating to social media account of the prospective account holder.

11. The method of claim 9, wherein the Social Security Administration access system authenticated and verifies the account holder based on a comparison between a name, address, date of birth and social security number associated with the account and a name, address and date of birth associated with an assigned and recorded social security number.

12. The method of claim 9, further comprising initiating a fourth authentication and verification of the account holder via an international credit bureau.

13. The computer-readable media of claim 9, wherein the Social Security Administration access system authenticated and verifies the account holder based on a comparison between a plurality of data elements associated with the account and a plurality of data elements associated with an assigned and recorded social security number.

14. One or more non-transitory computer-readable media storing computer-executable instructions which, when executed by a processor on a computer system, perform a method for authenticating, verifying and digitally onboarding prospective account holders using an artificially-intelligent, dynamic, rules-based system, the method comprising:
receiving a digital request, from a prospective account holder, to open an account;
processing the digital request at a rules engine, said rules engine comprising a plurality of rules, each of the plurality of rules being associated with a dynamic, weighted score;
generating, at the rules engine, an authentication and verification score for the digital request;
performing at least one of the following:
initiating a first authentication and verification of the account holder using a social security number inputted into a credit bureau;
initiating a second authentication and verification of the account holder via a third-party person recognition system; and
initiating a third authentication and verification of the account holder via a Social Security Administration access system;
updating the authentication and verification score based on the first authentication and verification, second authentication and verification and/or third authentication and verification;
when the updated authentication and verification score is above a first predetermined threshold, creating an account for the account holder;
when the updated authentication and verification score is below a second predetermined threshold, failing to create the account for the account holder;
when the updated authentication and verification score is between the second predetermined threshold and the first predetermined threshold, performing a detailed review of data relating to the account holder;
upon completion of the detailed review of data relating to the account holder, identify whether the account holder is an electronically authenticatable and verifiable account holder;
when the account holder is an electronically authenticatable and verifiable, identifying one or more rules, included in the rules engine, that caused the authentication and verification score to be below the first predetermined threshold; and
lower a weighting of the one or more rules at the rules engine.

15. The computer-readable media of claim 14, wherein the third-party person recognition system authenticates and verifies the account holder based on at least one of:
records relating to when the prospective account holder registered for a mobile device;
records relating to a driver’s license of the prospective account holder; and
records relating to social media account of the prospective account holder.

16. The computer-readable media of claim 14, wherein the Social Security Administration access system authenticated and verifies the account holder based on a comparison between a name, address, date of birth and social security number associated with the account and a name, address and date of birth associated with an assigned and recorded social security number.

17. The computer-readable media of claim 14, wherein the Social Security Administration access system authenticated and verifies the account holder based on a comparison between a plurality of data elements associated with the account and a plurality of data elements associated with an assigned and recorded social security number.

18. The computer-readable media of claim 14, further comprising initiating a fourth authentication and verification of the account holder via international credit bureau.
